(19) United States
(12) Patent Application Publication
(10) Pub. No.: US 2015/0068114 A1
(43) Pub. Date: Mar. 12, 2015

(54) Control of ground surface radiative effects

(71) Applicant: James K. Bullis, Sunnyvale, CA (US)

(72) Inventor: James K. Bullis, Sunnyvale, CA (US)

(21) Appl. No.: 13/987,831

(22) Filed: Sep. 7, 2013

(51) Int. Cl. A01G 13/00

(52) U.S. Cl. CPC A01G 13/00
USPC 47/2

(57) ABSTRACT

Here invented is method and apparatus for control of ground surface radiative effects. A material is laid out in a field in anticipation of frost or in expectation of crop damage from powdery mildew. The material causes radiative heat loss to the cold night sky due to its low emissivity and it causes ultraviolet-C in natural sunlight to be directed upward to impinge on mildew spores on vegetation where it would be otherwise shaded from the sun.

This patent document contains material that is subject to copyright protection. Facsimile reproduction is allowed of the patent document or the patent disclosure as it appears in the Patent and Trademark Office patent file or records as allowed by US patent law, but otherwise all copyright rights are reserved.

### BACKGROUND OF THE INVENTION

1. Field of the Invention

This present invention relates to agricultural operations.

2. Description of the Prior Art

There is currently much concern about frost damage and mildew damage. Measures to deal with these problems are widely varied and widely known.

Temperatures internal to spacecraft are controlled by preventing radiative heat transfer, with no need for concern about convection that is an air requiring process. For surfaces not in the sun, radiative heat loss to the dark sky depends on outer surface temperature, outer surface emissivity, and of course, the very low temperature of the dark sky. Low emissivity surfaces do not lose much heat and high emissivity surfaces lose it rapidly. Surfaces in sunlight turn away heat as radiation that is specular or scattered.

A very low emissivity surface is that of aluminum foil where its emissivity is 04. Incident radiation from the sun on aluminum foil is turned back almost entirely by reflection. Almost no radiation emits from this material. The surface exposed to the night sky is the determining surface. It matters not much what is underneath.

Ground surfaces generally have emissivity near 1 so incident radiation from the sun is mostly absorbed and turned into heat and emitted radiation to the night sky takes away heat from the ground.

Frost concerns get serious at the beginning of the growing season, where, even though daytime heat transfer warms the ground, the rate of heat loss to the night sky can make the ground temperature go well below freezing. Air temperature is the direct issue, and this closely follows the ground temperature due to air to ground contact. Common practice involves fans that mix upper air, that is somewhat warmer, with the ground air that comes to freezing temperatures due to that ground contact.

Powdery mildew is another big agricultural problem. Spores of this fungus are readily killed by ultraviolet light, specifically UV-C which is abundantly provided by sun radiation. Shadows, including those of the underside of vegetation, foster growth due to both moisture presence and lack of the ultraviolet light.

### SUMMARY OF THE INVENTION

The invention is method and apparatus to create a surface in proximity to the ground that blocks night time radiative heat transfer to the cold sky and reflects daytime sun radiation to shine on the underside of crop foliage. This limits the night time low temperature swings that cause much crop damage. It also provides ultraviolet radiation to parts of plants that are generally not in sunlight, thereby killing powdery mildew spores.

Control of temperature requires covering of an extended area. Low emissivity material is laid on the ground of a field where this low emissivity surface covers at least half the area of that ground, where such ground is at least 1000 square feet in area. In general, large fields would be completely covered except for uncovered parts allowable near plants. The anticipated embodiment is aluminum foil with a backing of plastic mesh that is bonded to the aluminum. The backing could also be low cost plastic wrap. More simply, the material could be household aluminum foil rolled out in row spaces.

Control of powdery mildew such that fungicide spraying can be reduced involves ground coverage in the vicinity of all plants, which is, generally, complete ground area coverage.

Penetrations or porosity of the material is desired in most cases, though some arrangements that would channel rain water to near plant roots would be desirable in some farm situations.

The need for this surface would be short term, after pruning and until foliage was established for example. The material would be rolled out at the beginning of growing season and either rolled back up and saved or recycled, or allowed to disintegrate after it was no longer needed.

### BRIEF DESCRIPTION OF THE DRAWINGS

FIG. 1 Ground cover material in place in a field

FIG. 2 Aluminum foil bonded to plastic sheet

### DETAILED DESCRIPTION

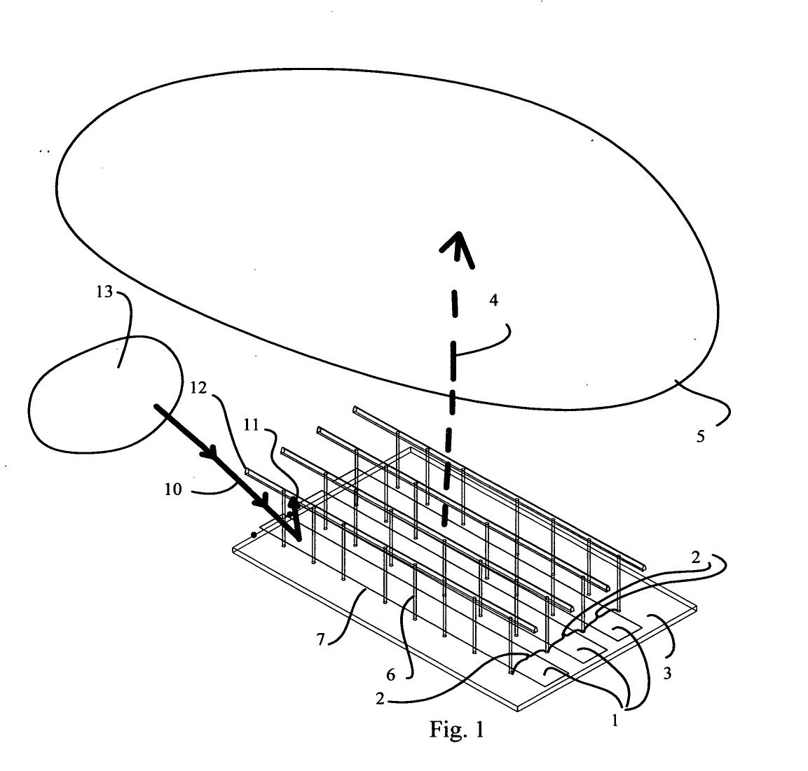

FIG. 1 shows an embodiment of the invention and method in a row crop application, such as a vineyard. The cover material is shown as long strips 1 laid on the ground 3 in plant row spaces 2. Radiation 4 to the dark sky 5 is blocked by the fact of low emissivity of the upward facing surface of the cover. Air seeps 7 under the cover material for convective heat transfer. Sunlight 10, including the spore killing ultraviolet C band energy, reflects to the underside 11 of plants 12. The sun 13 is shown as in a day condition, contradictorily to the night sky presence.

To have the dual effects of frost control and mildew control the covering needs to be below the level of growing foliage, so not covering the plants to prevent frost damage due to freezing temperatures of the general atmospheric air mass is specified. Such positioning below plant tops also avoids the concern that otherwise positioning over plants would aggravate powdery mildew problems, or any such crop problem associated with dampness or inadequate sunshine.

The invention is intended to replace the large, engine powered fans on towers that are often seen in vineyards. Covering fields on hillsides that are adjacent to flat areas would be particularly beneficial, since cold air notoriously hugs the ground and flows to lower levels. Still, covering the lower areas would provide more assurance of frost resistance.

The ultraviolet-C band is defined as the band from 100 to 280 nanometers in the electromagnetic spectrum. This is useful energy for control of powdery mildew, which is available whenever there can be exposure to the sun. In respect to the present invention, this type of energy is available at any time when the sun shines to a level below vegetation, thus enabling the covering to be effective by directing energy upward.

The method would also make pruning dates a little more flexible, since there would be basis for expecting that frost damage after bud-break would be unlikely.

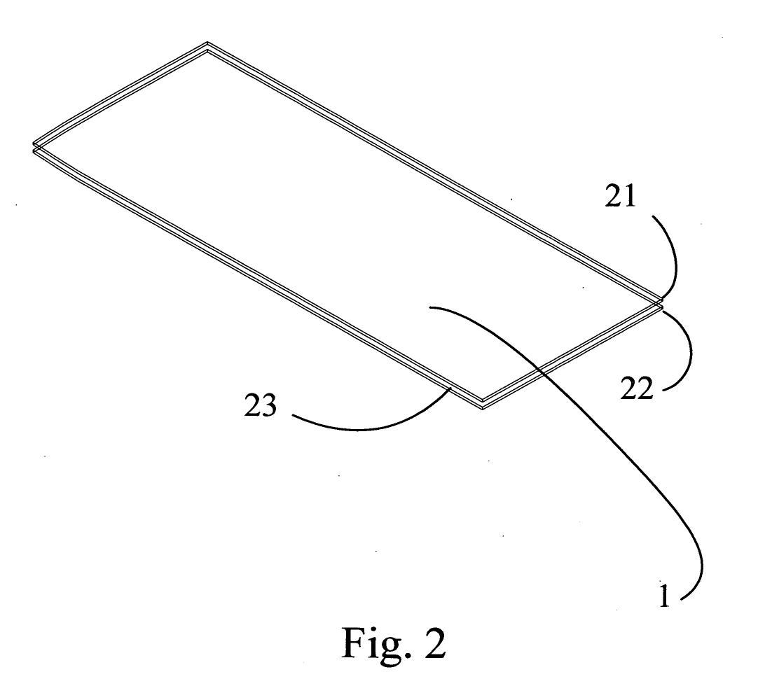

FIG. 2 shows a strip of aluminum foil 21 bonded to a strip of plastic 22. The aluminum foil has an emissivity of approximately 0.04 and can degrade considerably without losing all benefit.

Cost of the material is critical, since the area involved is large. Given wine grapes value over $2 per pound and yields are about one pound per foot, material costs of in the range of $0.10 make sense. Household foil can be had for about $0.02 per square foot, so covers made of this are feasible. Numerous backing materials are possible, including mesh plastic fencing. That has longer lasting qualities but polyethylene food wrap would also serve to hold the foil for a month or two, as needed for each crop in the many possible geographic areas. Adhesives 23 such as hot-melt glue, construction adhesive, double backed tape, are all options.

Cost of whatever shiny metal surface determines the realistic implementation. Recycling of aluminum is effective, so that may be a part of the method, where the aluminum works for a time and then is traded in on new material. Vapor deposition of aluminum on plastic seems to be functionally ideal, though present cost is not attractive.

For material laid on the ground, dirt or rocks occasionally placed on it would be reasonable for holding it in place in windy conditions, yet would only slightly reduced effectiveness of the covering.

The scope of the invention is to be defined by the appended claims.

I claim:

1. A method and apparatus for agricultural applications, where a covering surface is placed in anticipation of frost, where said surface is positioned in proximity to the ground level, where said covering surface blocks radiative heat transfer to the night sky, where said covering surface includes low emissivity material having emissivity less than 0.6 and said covering surface covers at least half of an agricultural field that is at least 1000 square feet in area.

2. A method and apparatus according to claim 1, where said emissivity is less than 0.4.

3. A method and apparatus according to claim 1, where said emissivity is less than 0.2.

4. A method and apparatus according to claim 1, where said covering surface is aluminum which is the upper surface that is exposed to said night sky.

5. A method and apparatus according to claim 1, that includes plastic reinforcing under said low emissivity material.

6. A method and apparatus according to claim 1, where said low emissivity material also is a reflective surface that directs sunlight upward to impinge on vegetation.

7. A method and apparatus for agricultural applications, where a covering surface is placed in anticipation of frost, where said surface is positioned in proximity to the ground level, where said covering surface blocks radiative heat transfer to the night sky, where said covering surface includes low emissivity material having emissivity less than 0.6 and said covering surface covers at least half of an agricultural field that is at least 1000 square feet in area, said covering surface is also is a reflective surface that directs more than half of incident sunlight energy upward to impinge on vegetation.

8. A method and apparatus according to claim 7, where said more than half of incident sunlight energy is in the ultraviolet-C band.

9. A method and apparatus for agricultural applications, where a covering surface is placed below a level of vegetation, where said covering surface is a reflective surface that directs more than half of incident sunlight energy upward to impinge on vegetation.

10. A method and apparatus for agricultural applications where upward directed energy is more than half of incident sunlight energy in the ultraviolet-C band.

11. A method and apparatus according to claim 9, where said covering surface is aluminum which is the upper surface that is exposed to daytime sunlight.

12. A method and apparatus according to claim 9, that includes plastic reinforcing under said reflective surface.

13. A method and apparatus according to claim 9, where said covering surface is utilized in a field greater than 1000 square feet.

14. A method and apparatus according to claim 9, where said covering surface is utilized in a field greater than 1000 square feet and covers at least half of said field.
